(19) United States
(12) Patent Application Publication
(10) Pub. No.: US 2022/0246336 A1
(43) Pub. Date: Aug. 4, 2022

(54) MANUFACTURING METHOD FOR RARE EARTH MAGNET

(71) Applicant: TOYOTA JIDOSHA KABUSHIKI KAISHA, Toyota-shi (JP)

(72) Inventors: Daisuke ICHIGOZAKI, Toyota-shi (JP); Noritsugu SAKUMA, Mishima-shi (JP); Akihito KINOSHITA, Mishima-shi (JP); Masaaki ITO, Anjo-shi (JP)

(73) Assignee: TOYOTA JIDOSHA KABUSHIKI KAISHA, Toyota-shi (JP)

(21) Appl. No.: 17/563,134

(22) Filed: Dec. 28, 2021

(30) Foreign Application Priority Data
Feb. 3, 2021 (JP) 2021-016023

(51) Int. Cl. H01F 1/059; H01F 1/055; H01F 41/02; H01F 1/08

(52) U.S. Cl. CPC H01F 1/059; H01F 1/0556; H01F 1/086; H01F 41/0266; H01F 1/0557

(57) ABSTRACT

There is provided a manufacturing method for a rare earth magnet, including forming a zinc-containing coating film on a surface of a particle of a samarium-iron-nitrogen-based magnetic powder to obtain a coated powder, subjecting the coated powder to compression molding to obtain a compacted powder body, and subjecting the compacted powder body to pressure sintering, in which a coating rate of the coating film with respect to an entire surface of the particle of the coated powder is 96% or more, and the formation of the coating film and the pressure sintering of the compacted powder body is carried out in a vacuum or an inert gas atmosphere, and the compression molding of the coated powder is carried out in the atmospheric air.

### CROSS-REFERENCE TO RELATED APPLICATION

This application claims priority to Japanese Patent Application No. 2021-016023 filed on Feb. 3, 2021, incorporated herein by reference in its entirety.

### BACKGROUND

### 1. Technical Field

The present disclosure relates to a manufacturing method for a rare earth magnet. The present disclosure particularly relates to a manufacturing method for a samarium-iron-nitrogen-based rare earth magnet.

### 2. Description of Related Art

As a high-performance rare earth magnet, a samarium-cobalt-based rare earth magnet and a neodymium-iron-boron-based rare earth magnet have been put into practical use. However, in recent years, a rare earth magnet other than these has been studied. For example, a rare earth magnet that contains samarium, iron, and nitrogen and has a magnetic phase having at least any one of a Th₂Zn₁₇-type crystal structure and a Th₂Ni₁₇-type crystal structure (hereinafter, may be referred to as a “samarium-iron-nitrogen-based rare earth magnet”) has been studied. The samarium-iron-nitrogen-based rare earth magnet is manufactured using a magnetic powder that contains samarium, iron, and nitrogen (hereinafter, may be referred to as a “samarium-iron-nitrogen-based magnetic powder”).

The samarium-iron-nitrogen-based magnetic powder contains a magnetic phase having at least any one of a Th₂Zn₁₇-type crystal structure and a Th₂Ni₁₇-type crystal structure. In this magnetic phase, nitrogen is conceived to be in a solid solution in an intrusion type in the samarium-iron crystal. As a result, in the samarium-iron-nitrogen-based magnetic powder, nitrogen is dissociated by heat and easily decomposed. For this reason, in a case of manufacturing a samarium-iron-nitrogen-based rare earth magnet (a molded body), it is needed to mold the samarium-iron-nitrogen-based magnetic powder at a temperature at which nitrogen in the magnetic phase is not dissociated.

Examples of such a molding method include a manufacturing method for a rare earth magnet disclosed in Japanese Unexamined Patent Application Publication No. 2019-186368 (JP 2019-186368 A). In this manufacturing method, a mixed powder of a samarium-iron-nitrogen-based magnetic powder and a powder containing zinc is subjected to compression molding in a magnetic field, and then the obtained compacted powder body is subjected to pressure sintering (including liquid phase sintering).

In a case where a compacted powder body of a mixed powder of a samarium-iron-nitrogen-based magnetic powder and a powder containing zinc is subjected to pressure sintering (including liquid phase sintering), a zinc component in the zinc-containing powder is diffused in a solid phase manner or a liquid phase manner on the surface of the particle of samarium-iron-nitrogen-based magnetic powder and sintered (solidified). As a result, according to the manufacturing method for a rare earth magnet disclosed in JP 2019-186368 A, the zinc-containing powder has a binder function.

In the samarium-iron-nitrogen-based powder, a small amount of Fe that has not constituted a magnetic phase having at least any one of a Th₂Zn₁₇-type crystal structure and a Th₂Ni₁₇-type crystal structure remains by forming an α-Fe phase. The coercive force is reduced by this α-Fe phase. The zinc component in the zinc-containing powder forms an α-Fe phase and a Zn—Fe phase (a reforming phase). Then, the Zn—Fe phase (the reforming phase) magnetically divides the magnetic phase to improve the coercive force. In this manner, the zinc-containing powder has a reforming function in addition to the above-described binder function.

### SUMMARY

A surface of a particle of a samarium-iron-nitrogen-based magnetic powder is very easily oxidized. In a case where a surface of a particle of a samarium-iron-nitrogen-based magnetic powder is oxidized, the magnetic phase in the samarium-iron-nitrogen-based magnetic powder decreases, and the residual magnetization decreases. For this reason, the manufacturing process in the manufacturing of the samarium-iron-nitrogen-based rare earth magnet (the molded body) has been carried out in a vacuum or an inert gas atmosphere in the related art.

In order to manufacture a samarium-iron-nitrogen-based rare earth magnet (a molded body) in a vacuum or an inert gas atmosphere, it is needed to enclose a device that is used for the manufacture in a container that can ensure airtightness, which causes the device to become large and complicated. Power is needed to maintain a vacuum in the container, and an inert gas is generally expensive. As a result, manufacturing in a vacuum or an inert gas atmosphere causes an increase in manufacturing cost. Based on these facts, the inventors of the present disclosure have found that objects that the manufacturing process is simplified and the manufacturing cost is reduced can be achieved in a case where the decrease in residual magnetization can be suppressed even in a part of processes by operations in the atmospheric air in the manufacturing of samarium-iron-nitrogen-based rare earth magnet (the molded body).

The present disclosure has been made to achieve the above objects. That is, an object of the present disclosure is to provide a manufacturing method for a rare earth magnet, with which the decrease in residual magnetization can be suppressed, the manufacturing process can be greatly simplified, and the manufacturing cost can be reduced even in a case where at least a part of process is carried out in the atmospheric air in the manufacturing of a samarium-iron-nitrogen-based rare earth magnet.

In order to achieve the above object, the inventors of the present disclosure have made extensive studies and have completed a manufacturing method for a rare earth magnet of the present disclosure. The manufacturing method for a rare earth magnet of the present disclosure includes the following aspects.

<1>A first aspect of the disclosure relates to a manufacturing method for a rare earth magnet. The manufacturing method includes forming a zinc-containing coating film on a surface of a particle of a magnetic powder that contains samarium, iron, and nitrogen and has a magnetic phase having at least any one of a Th₂Zn₁₇-type crystal structure and a Th₂Ni₁₇-type crystal structure, to obtain a coated powder, subjecting the coated powder to compression molding to obtain a compacted powder body, and subjecting the compacted powder body to pressure sintering.

In the manufacturing method, a coating rate of the coating film with respect to an entire surface of the particle of the coated powder is 96% or more, the formation of the coating film and the pressure sintering of the compacted powder body are carried out in a vacuum or an inert gas atmosphere, and the compression molding of the coated powder is carried out in an atmospheric air.

<2>In the manufacturing method according to <1>, the coated powder may be subjected to compression molding in a magnetic field to obtain the compacted powder body while the coated powder is magnetically oriented.

<3>In the manufacturing method according to <1>or <2>, the vacuum may be 1×10⁻¹ Pa or less in absolute pressure.

<4>In the manufacturing method according to any one of <1>to <3>, zinc may be sublimated in a vacuum and the zinc may be deposited on the surface of the particle of the magnetic powder to form the coating film.

<5>In the manufacturing method according to <4>, 20% to 50% by mass of the zinc may be deposited based on the magnetic powder.

<6>In the manufacturing method according to <4>, 20% to 30% by mass of the zinc may be deposited based on the magnetic powder.

<7>In the manufacturing method according to any one of <1>to <6>, the pressure sintering may be carried out at 350° C. to 380° C. for 1 minute to 5 minutes while a pressure of 100 MPa to 2,000 MPa is applied.

<8>In the manufacturing method according to any one of <1>to <7>, the pressure sintering may be carried out in an inert gas atmosphere.

According to the present disclosure, in a case where a coating film having a predetermined coating rate is formed in advance on the particle surface of a samarium-iron-nitrogen-based magnetic powder, it is possible to suppress the oxidation of the samarium-iron-nitrogen-based magnetic powder in the atmospheric air before the process of subjecting the coated powder having the coating film to pressure sintering. This makes it possible to provide a manufacturing method for a rare earth magnet, with which a decrease in residual magnetization can be suppressed even in a case where a coated powder is subjected to compression molding, before pressure sintering, in the atmospheric air to obtain a compacted powder body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is an illustrative diagram schematically illustrating a situation in a case where a particle of a coated powder is present in the atmospheric air;

FIG. 1B is an illustrative diagram schematically illustrating a situation in a case where the surface of the particle of the coated powder is oxidized;

FIG. 2 is an illustrative diagram illustrating an example of a method of forming a zinc-containing coating film on the surface of magnetic powder particles using a rotary kiln furnace;

FIG. 3 is an illustrative diagram illustrating an example of a method of forming a zinc-containing coating film on the surface of magnetic powder particles using a vapor deposition method; and

FIG. 4 is an illustrative diagram schematically illustrating an example of a die and a punch that are used in powder compaction.

### DETAILED DESCRIPTION OF EMBODIMENTS

Hereinafter, embodiments of a manufacturing method for a rare earth magnet of the present disclosure will be described in detail. The embodiments described below do not limit the manufacturing method for a rare earth magnet of the present disclosure.

Although not bound by theory, in the manufacturing method for a rare earth magnet of the present disclosure, the reason why it is possible to suppress the oxidation of a samarium-iron-nitrogen-based magnetic powder (hereinafter, may be simply referred to as a “magnetic powder”) in the atmospheric air in the process before pressure sintering will be described with reference to the drawings.

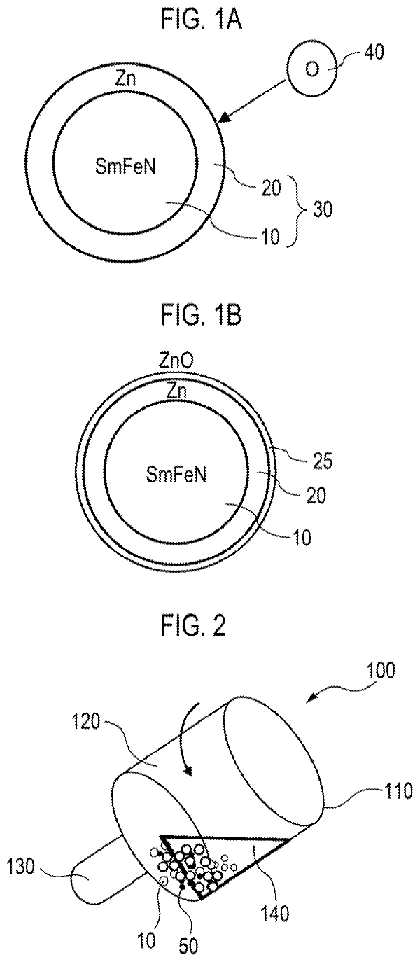

FIG. 1A is an illustrative diagram schematically illustrating a situation in a case where a particle of a coated powder is present in the atmospheric air. In addition, FIG. 1B is an illustrative diagram schematically illustrating a situation in a case where the surface of the particle of the coated powder is oxidized.

As illustrated in FIG. 1A, a coating film 20 is formed on the surface of a particle of a magnetic powder 10, and the particle of the magnetic powder 10 and the coating film 20 constitute a particle of a coated powder 30. An oxygen 40 is present in the atmospheric air. However, as illustrated in FIG. 1B, in the vicinity of the surface of the coating film 20, the oxygen 40 reacts with zinc in the coating film 20 to form an oxide coating film 25 that contains zinc oxide. For this reason, the direct contact between the oxygen 40 and the particle of the magnetic powder 10 is suppressed.

A rare earth magnet (a molded body) is obtained by subjecting a compacted powder body, which is obtained by subjecting the coated powder 30 to compression molding, to pressure sintering. Compression molding of the coated powder is carried out in the cold. The coating film 20 suppresses the oxidation of the surface of the particle of the magnetic powder 10 in the cold. For these reasons, it is possible to carry out compression molding of the coated powder in the atmospheric air. The details of “the cold” will be described later.

In order to impart anisotropy to the rare earth magnet (the molded body) and improve residual magnetization, a magnetic field is optionally applied during compression molding of the coated powder to magnetically orient the particle of the coated powder 30. In a case where a compacted powder body is formed, a molding die is charged with the coated powder and subjected to compression molding (cold pressing). For applying a magnetic field during compression molding, an electromagnetic coil is arranged around the molding die. However, for causing the inside of the molding die to be a vacuum or an inert gas atmosphere during compression molding, the device becomes complicated. In a case where compression molding is possible in the atmospheric air, it is possible to simplify the device, and, as a result, it is possible to greatly simplify the manufacturing method for a rare earth magnet. Among magnetic powders, a samarium-iron-nitrogen-based magnetic powder has a very large anisotropic magnetic field. For this reason, a large electromagnetic coil is needed for the orientation of the samarium-iron-nitrogen-based magnetic powder. As a result, compression molding in the atmospheric air is particularly advantageous since the device becomes very large and/or complicated in order to carry out powder compaction in a vacuum or inert gas atmosphere.

The configuration conditions of the manufacturing method for a rare earth magnet of the present disclosure, where the manufacturing method has been completed based on the findings and the like described so far, will be described below.

### Manufacturing Method for Rare Earth Magnet

The manufacturing method for a rare earth magnet of the present disclosure includes a coating process, a compression molding process, and a pressure sintering process. Further, in the compression molding process, a magnetic field application process may be optionally added. Hereinafter, each process will be described.

### Coating Process

This process is a process of forming a zinc-containing coating film on a surface of a particle of a magnetic powder that contains samarium, iron, and nitrogen and has a magnetic phase having at least any one of a Th₂Zn₁₇-type crystal structure and a Th₂Ni₁₇-type crystal structure, to obtain a coated powder. The zinc-containing coating film means a coating film containing a zinc element, and typically means at least any one of a coating film containing metallic zinc and a coating film containing a zinc alloy. The metallic zinc means unalloyed zinc.

As described above, the magnetic powder that contains samarium, iron, and nitrogen and has a magnetic phase having at least any one of a Th₂Zn₁₇-type crystal structure and a Th₂Ni₁₇-type crystal structure may be simply referred to as the “magnetic powder”. Details of the magnetic powder will be described later.

In order to suppress the oxidation of the magnetic powder, a zinc-containing coating film is formed on the surface of the particle of the magnetic powder in a vacuum or an inert gas atmosphere. In a case where the coating film is formed in a vacuum or an inert gas atmosphere and the oxidation of the magnetic powder can be suppressed and a predetermined coating rate can be obtained, the forming method for a coating film is not particularly limited. Since the coating film of the coated powder forms a reforming phase with the a-Fe phase in the magnetic powder during the subsequent pressure sintering process, the coated powder may be reformed or may not be reformed at the stage of the coating process.

Examples of the forming method for a coating film include a method using a rotary kiln furnace, a vapor deposition method, and a kneading method. These methods may be combined. Hereinafter, each of these methods will be briefly described.

### Method Using Rotary Kiln Furnace

FIG. 2 is an illustrative diagram illustrating an example of a method of forming a zinc-containing coating film on the surface of magnetic powder particles using a rotary kiln furnace.

A rotary kiln furnace 100 includes a stirring drum 110. The stirring drum 110 has a material housing unit 120, a rotating shaft 130, and a stirring plate 140. A rotating unit (not illustrated in the drawing), such as an electric motor, is connected to the rotating shaft 130.

The material housing unit 120 is charged with the magnetic powder 10 and a zinc-containing powder 50. The zinc-containing powder 50 will be described later. Then, the material housing unit 120 is heated by a heater (not illustrated in the drawing) while the stirring drum 110 is rotated.

In a case where the material housing unit 120 is heated to a temperature lower than the melting point of the zinc-containing powder 50, a zinc component of the zinc-containing powder 50 is diffused in a solid phase manner or vapor-deposited on the surface of the particle of the magnetic powder 10. As a result, a zinc-containing coating film is formed on the surface of the particle of the samarium-iron-nitrogen-based magnetic powder.

When the material housing unit 120 is heated to a temperature lower than the melting point of the zinc-containing powder 50, the zinc-containing powder 50 is sublimated and the zinc component of the zinc-containing powder 50 is deposited in a case where the material housing unit is put into a vacuum state. In the case of the deposition by sublimation, zinc vapor reaches every corner of the individual particles of the magnetic powder 10, and zinc can be uniformly deposited on the surface of the particles of the magnetic powder to form the coating film 20. As a result, a desired coating rate can be obtained even in a case where the amount of zinc deposited is small. Since zinc does not exhibit magnetism, the fact that a desired coating rate can be obtained with a small amount of zinc deposited is preferable.

In a case where zinc is deposited by sublimation, in order to obtain a desired coating rate, the zinc content of the zinc-containing powder may be 20% by mass or more, 22% by mass or more, or 25% by mass or more, and may be 50% by mass or less, 45% by mass or less, 40% by mass or less, or 30% by mass or less, based on the magnetic powder.

In a case where zinc is deposited in a vacuum, the pressure may be 1×10⁻¹ Pa or less, 1×10⁻² Pa or less, 1×10⁻³ Pa or less, 1×10⁻⁴ Pa or less, 1×10^{-≡}Pa or less, 1×10⁻⁶ Pa or less, or 1×10⁻⁷ Pa or less in terms of absolute pressure from the viewpoints of the suppression of the oxidation of the magnetic powder and the sublimation of zinc. On the other hand, there is no practical problem even in a case where the pressure is not excessively reduced, and the atmospheric pressure may be 1×10⁻⁸ Pa or more as long as the above-described atmospheric pressure is satisfied.

In a case where the material housing unit 120 is heated to the melting point of the zinc-containing powder 50 or higher, a melt of the zinc-containing powder is obtained, the melt and a magnetic material raw material powder 150 come into contact with each other, and in a case where the material housing unit 120 is cooled in that state, a zinc-containing coating film is formed on the surface of the magnetic powder particle. In a case where the material housing unit 120 is heated to the melting point of the zinc-containing powder 50 or higher, the material housing unit 120 preferably has an inert gas atmosphere. The inert gas atmosphere includes a nitrogen gas atmosphere.

The operating conditions of the rotary kiln furnace 100 may be appropriately determined so that a desired coating film is obtained.

In a case where the melting point of the zinc-containing powder is denoted by T, the heating temperature of the material housing unit is, for example, (T−50)° C. or higher, (T−40)° C. or higher, (T−30)° C. or higher, (T−20)° C. or higher, (T−10)° C. or higher, or T° C. or higher, and may be (T+50)° C. or lower, (T+40)° C. or lower, (T+30)° C. or lower, (T+20)° C. or lower, or (T+10)° C. or lower. In a case where the zinc-containing powder is a metallic zinc-containing powder, T is the melting point of zinc. In addition, in a case where the zinc-containing powder is a zinc alloy-containing powder, T is the melting point of the zinc alloy.

The rotation speed may be, for example, 5 rpm or more, 10 rpm or more, or 20 rpm or more, and may be 200 rpm or less, 100 rpm or less, or 50 rpm or less. The rotation time (the coating film forming time) may be appropriately determined according to the rotation speed and the processing amount. The rotation time (the coating film forming time) may be, for example, 10 minutes or more, 20 minutes or more, 40 minutes or more, 60 minutes or more, 80 minutes or more, 100 minutes or more, or 120 minutes or more, and may be 240 minutes or less, 180 minutes or less, or 150 minutes or less.

After forming the coating film 20 on the surface of the particle of the magnetic powder 10, a bounded body may be pulverized in a case where the particles of the coated powder 30 are bound to each other. The pulverizing method is not particularly limited, and examples thereof include a ball mill, a jaw crusher, a jet mill, a cutter mill, and a method of carrying out pulverization using a combination thereof.

### Vapor Deposition Method

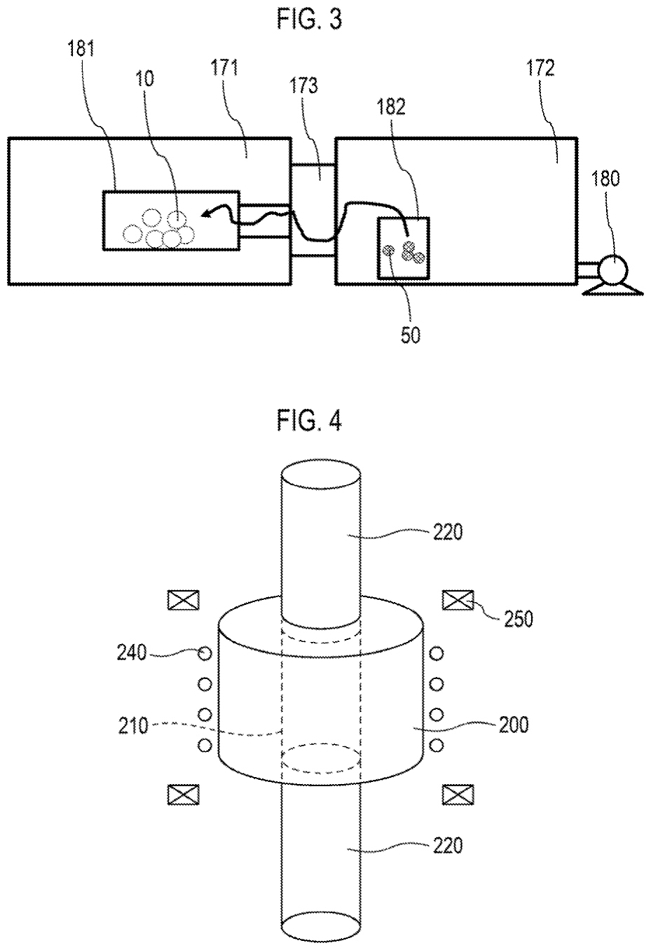

FIG. 3 is an illustrative diagram illustrating an example of a method of forming a zinc-containing coating film on the surface of magnetic powder particles using a vapor deposition method.

The magnetic powder 10 is housed in a first container 181 and the zinc-containing powder 50 is housed in a second container 182. The first container 181 is housed in a first heat treatment furnace 171 and the second container 182 is housed in a second heat treatment furnace 172. The first heat treatment furnace 171 and the second heat treatment furnace 172 are connected by a connecting path 173. The first heat treatment furnace 171, the second heat treatment furnace 172, and the connecting path 173 have airtightness, and a vacuum pump 180 is connected to the second heat treatment furnace.

After reducing the pressure in the inside of the first heat treatment furnace 171, the second heat treatment furnace 172, and the connecting path 173 with the vacuum pump 180, the insides of thereof are heated. Then, zinc-containing vapor is generated from the zinc-containing powder 50 is housed in the second container 182. The zinc-containing vapor moves from the inside of the second container 182 to the inside of the first container 181 as indicated by the solid arrow in FIG. 3.

The zinc-containing vapor that has moved to the inside of the first container 181 is cooled to form (be vapor-deposited) the coating film 20 on the surface of the particle of the magnetic powder 10. The vicinity of the interface between the coating film 20 obtained in this manner and the surface of the particle of the magnetic powder 10 is substantially not reformed.

In a case where the first container 181 is a rotary container, it can serve like a kiln furnace, and the coating rate of the coating film 20 to be formed on the surface of the magnetic powder 10 can be further increased. The coating rate will be described later.

The conditions for forming the coating film 20 by the method illustrated in FIG. 3 may be appropriately determined so that a desired coating film is obtained.

The temperature (the heating temperature of the samarium-iron-nitrogen-based magnetic powder) of the first heat treatment furnace is, for example, 120° C. or higher, 140° C. or higher, 160° C. or higher, 180° C. or higher, 200° C. or higher, or 220° C. or higher, and may be 410° C. or lower, 400° C. or lower, 380° C. or lower, 360° C. or lower, 340° C. or lower, 320° C. or lower, 300° C. or lower, 280° C. or lower, or 260° C. or lower.

In a where the melting point of the zinc-containing powder 50 is denoted by T, the temperature (the heating temperature of the zinc-containing powder 50) of the second heat treatment furnace is, for example, (T−30)° C. or higher, (T−20)° C. or higher, (T−10)° C. or higher, T° C. or higher, (T+20)° C. or higher, (T+40)° C. or higher, (T+60)° C. or higher, (T+80)° C. or higher, (T+100)° C. or higher, or (T+120)° C. or higher, may be (T+200)° C. or lower, (T+180)° C. or lower, (T+160)° C. or lower, or (T+140)° C. or lower. In a case where the zinc-containing powder is a metallic zinc-containing powder, T is the melting point of zinc. In addition, in a case where the zinc-containing powder is a zinc alloy-containing powder, T is the melting point of the zinc alloy. A zinc-containing bulk material may be housed in the second container 182. However, from the viewpoint of rapidly melting a charged material in the second container 182 and generating zinc-containing vapor from the obtained melt, it is preferable to house the zinc-containing powder in the second container 182.

The first heat treatment furnace and the second heat treatment furnace have a reduced pressure atmosphere in order to promote the generation of the zinc-containing steam and prevent the oxidation of the magnetic powder 10, the zinc-containing powder 50, the coating film 20, and the like. The atmospheric pressure may be, for example, 1×10⁻¹ Pa or less, 1×10⁻² Pa or less, 1×10⁻³ Pa or less, 1×10⁻⁴ Pa or less, 1×10⁻⁵ Pa or less, 1×10⁻⁶ Pa or less, or 1×10⁻⁷ Pa or less in terms of absolute pressure. On the other hand, there is no practical problem even in a case where the pressure is not excessively reduced, and the atmospheric pressure may be 1×10⁻⁸ Pa or more as long as the above-described atmospheric pressure is satisfied. In a case where the temperature of the second heat treatment furnace is within the above-described temperature range and less than T° C., the atmospheric pressure is lowered as much as possible within the above-described range so that the zinc-containing powder 50 is easily sublimated.

In a case where the first container 181 is a rotary container, the rotation speed may be, for example, 5 rpm or more, 10 rpm or more, or 20 rpm or more, and may be 200 rpm or less, 100 rpm or less, or 50 rpm or less.

In the vapor deposition method as well, after forming the zinc-containing coating film 20 on the surface of the particle of the magnetic powder 10, a bounded body may be pulverized in a case where the particles of the coated powder 30 are bound to each other. The pulverizing method is not particularly limited, and examples thereof include a ball mill, a jaw crusher, a jet mill, a cutter mill, and a method of carrying out pulverization using a combination thereof.

### Kneading Method

A zinc-containing powder is very soft as compared with the magnetic powder. For this reason, in a case where the magnetic powder is kneaded with the zinc-containing powder, the particle of the zinc-containing powder is deformed, and the deformed material (the zinc-containing material) adheres to the outer periphery of the particle of the magnetic powder to form a coating film. The kneading method is not particularly limited as long as a desired coating rate can be obtained. From the viewpoint of deforming the particle of the zinc-containing powder, it is preferable to carry out kneading using, for example, a ball mill, an attritor, a Muller wheel mixer, a mechanofusion, or NOBILTA (registered trade name). These methods may be combinedly used.

In the kneading method as well, after forming the zinc-containing coating film on the surface of the particle of the magnetic powder, a bounded body may be pulverized in a case where the particles of the coated powder are bound to each other. The pulverizing method is not particularly limited, and examples thereof include a ball mill, a jaw crusher, a jet mill, a cutter mill, and a method of carrying out pulverization using a combination thereof.

### Coating Rate

As described above, according to the manufacturing method for a rare earth magnet of the present disclosure, the coating film formed on the surface of the particle of the magnetic powder enables the powder compaction of the coated powder in the atmospheric air. In a case where the coating rate is 96% or more, 97% or more, 98% or more, or 99% or more, it is possible to suppress the oxidation of the magnetic particle in the coated powder and to suppress the decrease in residual magnetization within a range in which there is substantially no problem. The higher the coating rate is, the more preferable it is, and the coating rate is ideally 100%.

The coating rate is a coating proportion (percentage) of the coating film with respect to the entire surface of the particle of the coated powder. The coating rate (%) is determined as follows.

Regarding the coated powder, the composition information on the constituent elements of the magnetic powder and the coating film is obtained using X-ray photoelectron spectroscopy (XPS). Then, the coating rate (%) is calculated by the following expression.

The coating rate (%)=[(the total of the composition information on each constituent element of the coating film)/{(total of the composition information on each constituent element of the magnetic powder)+(the total of the composition information on each constituent element of the coating film)}]×100

In a case where the magnetic powder is composed of, for example, Sm, Fe, and N, the total of the composition information on each constituent element of the magnetic powder means the total of the composition information on each of Sm, Fe, and N. Further, in a case where the coating film is, for example, metallic zinc, the total of the composition information on each constituent element of the coating film means the composition information on Zn. In a case where the coating film is, for example, a zinc alloy, the total of the composition information on each constituent element of the coating film means the total of the composition information on each of Zn and the alloy elements. In a case where the zinc alloy is, for example, a Zn—Al alloy, the total of the composition information on each constituent element of the coating film means the total of the composition information on each of Zn and Al.

For example, the composition information on Zn means the mass of Zn present, which is obtained by measuring the XPS spectrum of the coated particle and determined from the peak intensity of the obtained XPS spectrum. In a case where the magnetic powder is composed of, for example, Sm, Fe, and N, and the coating film is, for example, metallic zinc, the coating rate (%) is calculated as follows.

The coating rate (%)=(the mass of Zn present)/(the masses of Sm, Fe, N, and Zn present)×100

### Compression Molding Process

This process is a process of subjecting the coated powder to compression molding to obtain a compacted powder body at atmospheric pressure. In the manufacturing method for a rare earth magnet of the present disclosure, since a coated powder having a predetermined coating rate is used, the oxidation of the magnetic powder can be suppressed even in a case where the coated powder is subjected to compression molding at atmospheric pressure. The compression molding method is not particularly limited. Examples thereof include a method using a mold that has a die and a punch. FIG. 4 is an illustrative diagram schematically illustrating an example of a mold that is used in powder compaction. A die 200 has a cavity 210, and a punch 220 moves slidingly inside the cavity. The coated powder is housed in the cavity 210 of the die 200, and then the punch 220 is moved to subject the coated powder to compression molding. In a case where the coated powder is subjected to compression molding while a magnetic field is applied, an electromagnetic coil 250 may be arranged as illustrated in FIG. 4. In addition, in a case where the same die 200 and punch 220 are used for the powder compaction and the pressure sintering, a heater 240 for heating may be arranged.

From the viewpoint of increasing the density of the rare earth magnet (the molded body), it is preferable that the pressure during compression molding is large as long as the die 200 and the punch 220 are not damaged. The pressure during compression molding may be, for example, 10 MPa or more, 50 MPa or more, 100 MPa or more, 200 MPa or more, 250 MPa or more, or 300 MPa or more, and may be 5,000 MPa or less, 4,000 MPa or less, 3,000 MPa or less, 2,000 MPa or less, 1,000 MPa or less, 500 MPa or less, 400 MPa or less, or 350 MPa or less. The pressure application time is not particularly limited, and it may be 0.2 minutes or more, 0.4 minutes or more, 0.6 minutes or more, 0.8 minutes or more, or 1 minute or more, and may be 5 minutes or less, 3 minutes or less, or 2 minutes or less.

In a case where the coated powder is subjected to compression molding in the cold, a compacted powder body is obtained. The “cold” means a temperature at which sintering (solidification) of a coated powder does not substantially start. The temperature at which sintering (solidification) starts refers to a temperature at which a zinc component in the zinc-containing powder starts to be diffused in a solid phase manner or a liquid phase manner on the surface of the particle of the magnetic powder. The temperature of the coated powder during compression molding may be, for example, 0° C. or higher, 10° C. or higher, 20° C. or higher, 30° C. or higher, or 40° C. or higher, and may be 100° C. or lower, 80° C. or lower, 60° C. or lower, or 50° C. or lower. Typically, the coated powder is subjected the compression molding at room temperature.

### Magnetic Field Application Process

The coated powder may be subjected the compression molding in a magnetic field. At that time, the magnetic field is applied to the coated powder. This makes it possible for the coated powder under pressure compression to be magnetically oriented, and thus it is possible to impart anisotropy to the rare earth magnet (the sintered body). The direction in which the magnetic field is applied is not particularly limited; however, typically, the magnetic field is applied in a direction substantially perpendicular to the compression molding direction of the coated powder.

The magnetic field application method is not particularly limited. Examples of the magnetic field application method include a method of charging the inside of a container with a coated powder and applying a magnetic field to the coated powder. The container is not particularly limited as long as it is possible to cause a magnetic field to act on the inside of the container. For example, a die and a punch with which the coated powder is subjected to compression molding can be used as the container. In a case a magnetic field is applied, for example, a magnetic field generator is installed on the outer periphery of the container. In addition, in a case where the applied magnetic field is large, for example, a magnetizing device or the like can be used.

The magnitude of the applied magnetic field may be, for example, 100 kA/m or more, 150 kA/m or more, 160 kA/m or more, 300 kA/m or more, 500 kA/m or more, 1,000 kA/m, or 1,500 kA/m or more, and may be 4,000 kA/m or less, 3,000 kA/m or less, 2,500 kA/m or less, or 2,000 kA/m or less. Examples of the magnetic field application method include a method of applying a static magnetic field using an electromagnet and a method of applying a pulse magnetic field using an alternating current.

### Pressure Sintering Process

The coated powder is subjected to pressure sintering in a vacuum or an inert gas atmosphere. The vacuum or the inert gas atmosphere suppresses the oxidation of the magnetic powder and the like. From the viewpoint of suppressing oxidation, the inert gas atmosphere is preferable. The inert gas atmosphere includes a nitrogen gas atmosphere.

In a case of carrying out pressure sintering in a vacuum, the atmospheric pressure may be, for example, 1×10⁻¹ Pa or less, 1×10⁻² Pa or less, 1×10⁻³ Pa or less, 1×10⁻⁴ Pa or less, 1×10⁻⁵ Pa or less, 1×10⁻⁶ Pa or less, or 1×10⁻⁷ Pa or less in terms of absolute pressure. On the other hand, there is no practical problem even in a case where the pressure is not excessively reduced, and the atmospheric pressure may be 1×10⁻⁸ Pa or more as long as the above-described atmospheric pressure is satisfied. During pressure sintering, the temperature is high and the pressure is high, and thus the magnetic powder and the like are easily oxidized. For this reason, 1×10⁻⁵ Pa or less, 1×10⁻⁶ Pa or less, or 1×10⁻⁷ Pa or less is preferable.

Conditions, such as temperature, pressure, and time during pressure sintering, can be appropriately determined so that the nitrogen in the magnetic phase of the magnetic powder is not dissociated and the coated powder is subjected to solid phase sintering or liquid phase sintering.

The pressure sintering temperature may be, for example, 350° C. or higher, 360° C. or higher, or 370° C. or higher, and may be 500° C. or lower, 480° C. or lower, 460° C. or lower, 440° C. or lower, 420° C. or lower, 400° C. or lower, or 380° C. or lower. From the viewpoint of preventing excessive reforming, the pressure sintering temperature is preferably 380° C. or lower.

The pressure sintering pressure may be, for example, 200 MPa or more, 300 MPa or more, 400 MPa or more, 500 MPa, 600 MPa or more, 700 MPa or more, or 900 MPa or more, and may be 2,000 MPa or less, 1,500 MPa or less, or 1,000 MPa or less.

The pressure sintering time may be, for example, 1 minute or more, 2 minutes or more, or 3 minutes or more, and may be 120 minutes or less, 60 minutes or less, 30 minutes or less, 10 minutes or less, or 5 minutes or less. From the viewpoint of preventing excessive reforming, the pressure sintering time is preferably 5 minutes or less.

The pressure sintering method is not particularly limited as long as it satisfies what has been described so far. Examples of the pressure sintering method include a method using a die and a punch.

Next, the magnetic powder and the coating film composition will be described.

### Magnetic Powder

The magnetic powder that is used in the manufacturing method for a rare earth magnet of the present disclosure contains samarium, iron, and nitrogen and contains a magnetic phase having at least any one of a Th₂Zn₁₇-type crystal structure and a Th₂Ni₁₇-type crystal structure. Examples of the crystal structure of the magnetic phase include a phase having a TbCu₇-type crystal structure in addition to the above-described structures. Here, Th is thorium, Zn is zinc, Ni is nickel, Tb is terbium, and Cu is copper.

The magnetic powder may contain, for example, a magnetic phase represented by a composition formula (Sm₍₁₋ᵢ₎Rᵢ)₂(Fe₍₁₋ⱼ₎Coⱼ)₁₇Nₕ. A rare earth magnet (hereinafter, may be referred to as a “result product”) obtained by the manufacturing method of the present disclosure exhibits magnetic properties due to the magnetic phase in the magnetic powder. In the above, i, j, and h indicate a molar ratio. Sm is samarium, Fe is iron, Co is cobalt, and N is nitrogen.

The magnetic phase in the magnetic powder may contain R within a range in which the effects of the manufacturing method of the present disclosure and the magnetic properties of the result product are not inhibited. Such a range is represented by i in the above composition formula. i may be, for example, 0 or more, 0.10 or more, or 0.20 or more, and may be 0.50 or less, 0.40 or less, or 0.30 or less. R is one or more elements selected from rare earth elements other than samarium, yttrium, and zirconium. In the present specification, the rare earth elements are scandium, lanthanum, cerium, praseodymium, neodymium, promethium, samarium, europium, gadolinium, terbium, dysprosium, holmium, erbium, thulium, ytterbium, and ruthenium.

Regarding (Sm₍₁₋ᵢ₎Rᵢ)₂(Fe₍₁₋ⱼ₎Coⱼ)₁₇Nₕ, a position of Sm in Sm₂(Fe₍₁₋ⱼ₎Coⱼ)₁₇Nₕ is typically substituted with R; however, it is not limited to thereto. For example, a part of R's may be arranged in an intrusion type in Sm₂(Fe₍₁₋ⱼ₎Coⱼ)₁₇Nₕ.

The magnetic phase in the magnetic powder may contain Co within a range in which the effects of the manufacturing method for a rare earth magnet of the present disclosure and the magnetic properties of the result product are not inhibited. Such a range is represented by j in the above composition formula. j may be 0 or more, 0.10 or more, or 0.20 or more, and may be 0.52 or less, 0.40 or less, or 0.30 or less.

Regarding (Sm₍₁₋ᵢ₎Rᵢ)₂(Fe₍₁₋ⱼ₎Coⱼ)₁₇Nₕ, a position of Fe in (Sm₍₁₋ᵢ₎Rᵢ)₂(Fe₍₁₋ⱼ₎Coⱼ)₁₇Nₕ is typically substituted with Co; however, it is not limited to thereto. For example, a part of Co's may be arranged in an intrusion type in (Sm₍₁₋ᵢ₎Rᵢ)₂(Fe₍₁₋ⱼ₎Coⱼ)₁₇Nₕ.

In a case where N is present in an intrusion type in the crystal particle represented by (Sm₍₁₋ᵢ₎Rᵢ)₂(Fe₍₁₋ⱼ₎Coⱼ)₁₇, the magnetic phase in the magnetic powder contributes to the exhibition and improvement of the magnetic properties.

h may be 1.5 to 4.5 in (Sm₍₁₋ᵢ₎Rᵢ)₂(Fe₍₁₋ⱼ₎Coⱼ)₁₇Nₕ, which is typically (Sm₍₁₋ᵢ₎Rᵢ)₂(Fe₍₁₋ⱼ₎CoⱼN₃. h may be 1.8 or more, 2.0 or more, or 2.5 or more, and may be 4.2 or less, 4.0 or less, or 3.5 or less. The content of (Sm₍₁₋ᵢ₎Rᵢ)₂(Fe₍₁₋ⱼ₎Coⱼ)₁₇N₃ with respect to the entire (Sm₍₁₋ᵢ₎Rᵢ)₂(Fe₍₁₋ⱼ₎Coⱼ)₁₇Nₕ, is preferably 70% by mass or more, more preferably 80% by mass or more, and still more preferably 90% by mass or more. On the other hand, not all (Sm₍₁₋ᵢ₎Rᵢ)₂(Fe₍₁₋ⱼ₎Coⱼ)₁₇Nₕ need to be (Sm₍₁₋ᵢ₎Rᵢ)₂(Fe₍₁₋ⱼ₎Coⱼ)₁₇N₃. The content of (Sm₍₁₋ᵢ₎Rᵢ)₂(Fe₍₁₋ⱼ₎Coⱼ)₁₇N₃ with respect to the entire (Sm₍₁₋ᵢ₎Rᵢ)₂(Fe₍₁₋ⱼ₎Coⱼ)₁₇Nₕ may be 99% by mass or less, 98% by mass or less, or 97% by mass or less.

The magnetic powder may contain oxygen, M¹, and unavoidable impurity elements in addition to the magnetic phase represented by (Sm₍₁₋ᵢ₎Rᵢ)₂(Fe₍₁₋ⱼ₎Coⱼ)₁₇Nₕ within a range in which the effects of the manufacturing method for a rare earth magnet of the present disclosure and the magnetic properties of the result product are substantially not inhibited. From the viewpoint of ensuring the magnetic properties of the result product, the content of the magnetic phase represented by(Sm₍₁₋ᵢ₎Rᵢ)₂(Fe₍₁₋ⱼ₎Coⱼ)₁₇Nₕ with respect to the entire magnetic powder may be 80% by mass or more, 85% by mass or more, or 90% by mass or more. On the other hand, there is no practical problem even in a case where the content of the magnetic phase represented by (Sm₍₁₋ᵢ₎Rᵢ)₂(Fe₍₁₋ⱼ₎Coⱼ)₁₇Nₕ is not excessively high with respect to the entire magnetic powder. As a result, the content thereof may be 99% by mass or less, 98% by mass or less, or 97% by mass or less. The remainder of the magnetic phase represented by (Sm₍₁₋ᵢ₎Rᵢ)₂(Fe₍₁₋ⱼ₎Coⱼ)₁₇Nₕ becomes the content of oxygen and M¹. Further, a part of M¹'s may be present in the magnetic phase in an intrusion type and/or a substitution type.

Examples of M¹ described above include one or more elements selected from the group consisting of gallium, titanium, chromium, zinc, manganese, vanadium, molybdenum, tungsten, silicon, rhenium, copper, aluminum, calcium, boron, nickel, and carbon. The unavoidable impurity element means an impurity element of which the incorporation is unavoidable in the manufacturing of the magnetic powder or the like or an impurity element which causes a significant increase in manufacturing cost for avoiding the incorporation thereof. These elements may be present in the above-described magnetic phase in a substitution type and/or an intrusion type, or may be present in a phase other than the above-described magnetic phase. Alternatively, they may be present at the particle boundaries of these phases.

The particle size of the magnetic powder is not particularly limited as long as the result product has desired magnetic properties and the particle size does not affect the effect of the manufacturing method for a rare earth magnet of the present disclosure.

The particle size of the magnetic powder may be, for example, 1 μm or more, 2 μm or more, 3 μm or more, 4 μm or more, 5 μm or more, 6 μm or more, 7 μm or more, 8 μm or more, or 9 μm or more, and may be 20 μm or less, 19 μm or less, 18 μm or less, 17 μm or less, 16 μm or less, 15 μm or less, 14 μm or less, 13 μm or less, 12 μm or less, 11 μm or less, or 10 μm or less in terms of D₅₀. Here, D₅₀ means the median diameter. In addition, the D₅₀ of the magnetic powder is measured by, for example, a dry-type laser diffraction and scattering method or the like.

The manufacturing method for the magnetic powder is not particularly limited as long as the magnetic powder satisfies what has been described so far, and a commercially available product may be used. Examples of the manufacturing method for a magnetic powder include a method in which a samarium-iron alloy powder is manufactured from a samarium oxide and an iron powder by a reduction diffusion method, the samarium-iron alloy powder is subjected to heat treatment at the temperature of 600° C. or lower in an atmosphere, such as a mixed gas of nitrogen and hydrogen, nitrogen gas, ammonia gas, or the like, to obtain a samarium-iron-nitrogen-based magnetic powder. Alternatively, examples thereof include a method in which a samarium-iron alloy is manufactured by a melting method, the manufactured alloy is roughly pulverized to obtain a roughly pulverized particle, which is subsequently subjected to nitridization and further pulverization until a desired particle size is obtained. For pulverization, for example, a dry-type jet mill, a dry-type ball mill, a wet-type ball mill, a wet-type bead mill, or the like can be used. In addition, these methods may be combinedly used.

### Coating Film Composition

The coating film has both a binder function and a reforming function. Since the coating film has a binder function, a sintered body can be obtained at a low temperature at which nitrogen in the magnetic phase is not dissociated. In addition, the coating film mainly forms a reforming phase with the α-Fe phase in the magnetic powder to suppress a reduction in coercive force. The coating film having such a function contains zinc. The reforming phase is conceived to be a zinc-iron phase (a Zn—Fe phase). Examples of the zinc-iron phase include a γ phase, a γ₁ phase, a δ₁ₖ phase, a δ₁ₚ phase, and a ζ phase.

Examples of the coating film having the above-described functions include a coating film containing metallic zinc, a coating film containing a zinc alloy, and a coating film containing metallic zinc and a zinc alloy. The metallic zinc means unalloyed zinc. The purity of the metallic zinc coating film may be 95.0% by mass or more, 98.0% by mass or more, 99.0% by mass or more, or 99.9% by mass or more.

In a case where the coating film is formed by the rotary kiln method and/or the kneading method, for example, a powder containing a metallic zinc powder and/or a powder containing a zinc alloy is used. In particular, in a case where a powder containing a metallic zinc powder is used, a metallic zinc powder manufactured by a hydrogen plasma reaction method (a hydrogen plasma-metal reaction method (an HPMR method)) is used; however, the powder is not limited thereto. The metallic zinc powder manufactured by the hydrogen plasma reaction method has a very low oxygen content and absorbs oxygen contained in the magnetic material, which is advantageous for improving magnetic properties, particularly coercive force. From this viewpoint, in a case where the zinc-containing powder is used in the coating process, the oxygen content is preferably 5.0% by mass or less, more preferably 3.0% by mass or less, and still more preferably 1.0% by mass or less with respect to the entire zinc-containing powder. On the other hand, extremely reducing the oxygen content of the zinc-containing powder leads to an increase in manufacturing cost. From this, the oxygen content of the zinc-containing powder may be 0.1% by mass or more, 0.2% by mass or more, or 0.3% by mass or more with respect to the entire zinc-containing powder.

In the above description, for example, the “metallic zinc-containing powder” means that a substance that is unavoidably contained may be contained in addition to the metallic zinc powder. The content of the unavoidable impurities is preferably 5% by mass or less with respect to the entire powder containing metallic zinc. The unavoidable impurity is a substance that is unavoidably contained in the manufacturing of the metallic zinc powder or the like and is typically an oxide. The description made here is also applied to a powder other than the metallic zinc-containing powder.

In a case where a zinc alloy is represented by zinc-M², M² is preferably an element and an unavoidable impurity element, which alloy with zinc and causes the melting point (the melting start temperature) of the zinc alloy to be lower than the melting point of zinc and. This makes the pressure sintering at a lower temperature easy and makes it possible to suppress excessive reforming due to the reaction between the magnetic phase, in addition to the α-Fe phase, and the zinc component during pressure sintering.

Examples of M² that causes the melting point of the zinc alloy to be lower than the melting point of zinc include elements that form a eutectic alloy with zinc and M². Examples of such M² typically include tin, magnesium, and aluminum, and combinations thereof. Elements that do not impair the melting point lowering effect of these elements and the characteristics of the result product can also be selected as M². Further, the unavoidable impurity element means an impurity element of which the incorporation is unavoidable or an impurity element that causes a significant increase in manufacturing cost for avoiding the incorporation thereof, such as an impurity contained in the raw material.

In the zinc alloy represented by zinc-M², the proportion (in terms of molar ratio) of zinc and M² may be appropriately determined so that the pressure sintering temperature becomes proper. The proportion (in terms of molar ratio) of M² with respect to the entire zinc alloy may be, for example, 0.02 or more, 0.05 or more, 0.10 or more, or 0.20 or more, and may be 0.90 or less, 0.80 or less, 0.70 or less, 0.60 or less, 0.50 or less, 0.40 or less, or 0.30 or less.

Among the zinc alloys, a typical zinc-aluminum alloy will be further described. The zinc-aluminum alloy may contain 8% to 90% by atom of zinc and 2% to 10% by atom of aluminum. Alternatively, the zinc-aluminum alloy may contain 2% to 10% by atom of aluminum, where the remainder is zinc and unavoidable impurities.

The particle size of the metallic zinc powder and/or the zinc alloy powder that is used in the rotary kiln method and the kneading method is not particularly limited. However, in a case where the particle size becomes smaller than the particle size of the magnetic powder, coating rate is easily increased even in a case where the blending amount of the metallic zinc powder and/or the zinc alloy powder is small. The particle size of the metallic zinc powder and/or the zinc alloy powder may be, for example, more than 0.1 μm, 0.5 μm or more, 1 μm or more, or 2 μm or more, and may be 12 μm or less, 11 μm or less, 10 μm or less, 9 μm or less, 8 μm or less, 7 μm or less, 6 μm or less, 5 μm or less, or 4 μm or less in terms of D₅₀ (median diameter). The particle size of the metallic zinc powder and/or the zinc alloy powder is measured by, for example, a dry-type laser diffraction and scattering method or the like.

Hereinafter, the manufacturing method for a rare earth magnet of the present disclosure will be described in more detail with reference to Examples and Comparative Examples. The manufacturing method for a rare earth magnet of the present disclosure is not limited to the conditions used in Examples below.

### Preparation of Sample

A sample of a rare earth magnet was prepared as follows.

### Example 1

Using the device of FIG. 2, a zinc-containing coating film was formed on the surface of the magnetic powder particle to obtain a coated powder. As the magnetic powder, a powder having a D₅₀ of 3.16 μm was used. As the zinc-containing powder, a metallic zinc powder manufactured by KAMITE Co., Ltd. was used. Regarding this metallic zinc powder, D₅₀ was 0.5 μm, and the oxygen content was 1,000 mass ppm or less. The oxygen content was measured by the infrared absorption method. The using amount (the blending amount) of the metallic zinc powder was 30% by mass based on the magnetic powder.

Regarding the operating conditions of the device (the rotary kiln furnace) in FIG. 2, the temperature inside the furnace was 410° C., and the absolute pressure inside the furnace was 1×10⁻² Pa or less. In addition, the rotary kiln furnace was rotated at 6 rpm for 100 minutes.

A cavity of a 7 mm square mold made of hard metal was charged with 1 g of the coated powder prepared as described above and subjected to compression molding at 300 MPa in the atmospheric air using a hydraulic pressing machine to obtain a compacted powder body. No magnetic field was applied during compression molding.

The compacted powder body prepared as described above was subjected to pressure sintering in an argon gas atmosphere (97,000 Pa). The pressure sintering temperature was 380° C., the pressure sintering pressure was 300 MPa, and the pressure sintering time was 5 minutes.

### Example 2

A sample of Example 2 was prepared in the same manner as in Example 1 except that the using amount (the blending amount) of the metallic zinc powder was 20% by mass based on the magnetic powder.

### Comparative Example 1

A sample of Comparative Example 1 was prepared in the same manner as in Example 1 except that pressure sintering was carried out in the atmospheric air.

### Comparative Example 2

A sample of Comparative Example 2 was prepared in the same manner as in Example 1 except that the using amount (the blending amount) of the metallic zinc powder was 15% by mass based on the magnetic powder.

### Comparative Example 3

A sample of Comparative Example 3 was prepared in the same manner as in Example 1 except that a coating film was not formed on the magnetic powder.

### Reference Example 1

A sample of Reference Example 1 was prepared in the same manner as in Example 1 except that the coated powder was subjected to compression molding in an argon gas atmosphere to obtain a compacted powder body.

### Reference Example 2

A sample of Reference Example 2 was prepared in the same manner as in Example 1 except that the coated powder was not subjected to compression molding and pressure sintering. That is, the sample of Reference Example 2 is a sample of the coated powder, as it is, of Example 1.

### Evaluation

The coating rate of the coated powder was measured by the method using the above-described X-ray photoelectron spectroscopy (XPS). In addition, the residual magnetization was measured using a vibrating sample magnetometer (VSM). The maximum applied magnetic field at the time of measurement was 2.0 T.

The results are shown in Table 1.

TABLE 1

| | | Coating process | | | | | | | | | | | Magnetic |
|---|---|---|---|---|---|---|---|---|---|---|---|---|---|
| | | Presence | | | | | | | | | | | property |
| | Magnetic | or | Zinc | | Coat- | Compression molding | | | Pressure sintering process | | | | Residual |
| | powder | absence | amount | | ing | (powder compaction) process | | | | Temper- | Pres- | | magneti- |
| | D₅₀ | of | (% by | Atmo- | rate | | Pressure | Time | | ature | sure | Time | zation |
| | (μm) | coating | mass) | sphere | (%) | Atmosphere | (MPa) | (minute) | Atmosphere | (° C.) | (MPa) | (minute) | (T) |
| Example 1 | 3.16 | Present | 30 | Vacuum | 100 | Atmospheric | 300 | 1 | Inert | 380 | 300 | 5 | 0.536 |
| | | | | | | air | | | | | | | |
| Example 2 | 3.16 | Present | 20 | Vacuum | 96 | Atmospheric | 300 | 1 | Inert | 380 | 300 | 5 | 0.535 |
| | | | | | | air | | | | | | | |
| Comparative | 3.16 | Present | 30 | Vacuum | 100 | Atmospheric | 300 | 1 | Atmospheric | 380 | 300 | 5 | 0.495 |
| Example 1 | | | | | | air | | | air | | | | |
| Comparative | 3.16 | Present | 15 | Vacuum | 95 | Atmospheric | 300 | 1 | Inert | 380 | 300 | 5 | 0.481 |
| Example 2 | | | | | | air | | | | | | | |
| Comparative | 3.16 | Absent | — | Vacuum | 0 | Atmospheric | 300 | 1 | Inert | 380 | 300 | 5 | 0.467 |
| Example 3 | | | | | | air | | | | | | | |
| Reference | 3.16 | Present | 30 | Vacuum | 100 | Inert | 300 | 1 | Inert | 380 | 300 | 5 | 0.537 |
| Example 1 | | | | | | | | | | | | | |
| Reference | 3.16 | Present | 30 | Vacuum | 100 | — | — | — | — | — | — | — | 0.539 |
| Example 2 | | | | | | | | | | | | | |

It can be confirmed that in Examples 1 and 2 in which a coated powder having a coating film having a coating rate of 96% or more is used, the same residual magnetization as in Reference Example 1 in which compression molding (powder compaction) is carried out in an inert gas atmosphere is obtained even in a case where compression molding (powder compaction) is carried out in the atmospheric air. On the other hand, it can be confirmed that in Comparative Example 2 having a coating film having a coating rate of less than 96% and Comparative Example 3 having no coating film (coating rate: 0%), the residual magnetization decreases in a case where compression molding (powder compaction) is carried out in the atmospheric air. In addition, it can be confirmed that even in a case where the coating rate is 100%, the residual magnetization decreases in a case where pressure sintering is carried out in the atmospheric air. Furthermore, it can be confirmed that Reference Example 1 in which all the processes were carried out in a vacuum or an inert gas atmosphere has a residual magnetization substantially equal to that of Reference Example 2 that is the coated powder as it is.

From these results, the effect of the manufacturing method for a rare earth magnet of the present disclosure can be confirmed.

What is claimed is:

1. A manufacturing method for a rare earth magnet, the manufacturing method comprising:
forming a zinc-containing coating film on a surface of a particle of a magnetic powder that contains samarium, iron, and nitrogen and has a magnetic phase having at least any one of a Th₂Zn₁₇-type crystal structure and a Th₂Ni₁₇-type crystal structure, to obtain a coated powder;
subjecting the coated powder to compression molding to obtain a compacted powder body; and
subjecting the compacted powder body to pressure sintering, wherein:
a coating rate of the coating film with respect to an entire surface of the particle of the coated powder is 96% or more;
the formation of the coating film and the pressure sintering of the compacted powder body are carried out in a vacuum or an inert gas atmosphere; and
the compression molding of the coated powder is carried out in an atmospheric air.

2. The manufacturing method according to claim 1, wherein the coated powder is subjected to compression molding in a magnetic field to obtain the compacted powder body while the coated powder is magnetically oriented.

3. The manufacturing method according to claim 1, wherein the vacuum is 1×10⁻¹ Pa or less in terms of absolute pressure.

4. The manufacturing method according to claim 1, wherein zinc is sublimated in a vacuum and the zinc is deposited on the surface of the particle of the magnetic powder to form the coating film.

5. The manufacturing method according to claim 4, wherein 20% to 50% by mass of the zinc is deposited based on the magnetic powder.

6. The manufacturing method according to claim 4, wherein 20% to 30% by mass of the zinc is deposited based on the magnetic powder.

7. The manufacturing method according to claim 1, wherein the pressure sintering is carried out at 350° C. to 380° C. for 1 minute to 5 minutes while a pressure of 100 MPa to 2,000 MPa is applied.

8. The manufacturing method according to claim 1, wherein the pressure sintering is carried out in an inert gas atmosphere.
